(19) United States
(12) Patent Application Publication
(10) Pub. No.: US 2006/0046011 A1
(43) Pub. Date: Mar. 2, 2006

(54) Method for key generation for digital rights control, recording medium, player, recorder and system for copy right control

(75) Inventors: Josephus Arnoldus Henricus Maria Kahlman, Eindhoven (NL); Rene Jozef Willem Debets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/542,134

(22) PCT Filed: Dec. 10, 2003
(86) PCT No.: PCT/IB03/06298

§ 371 Date: Jul. 12, 2005

(30) Foreign Application Priority Data
Jan. 16, 2003 (EP) 03100079.7

(51) Int. Cl. B32B 3/02

(52) U.S. Cl. 428/64.4

(57) ABSTRACT

When a recording medium is recorded using a method for control of the crosstalk between tracks using control points any change in track pitch will directly result in other optimum values for those control points. If the recording medium is copied by a bit copier the control point values are also copied without modification but because of a shift of the data in adjacent tracks relative to each other the control point values are no longer the optimum values. This can be used to distinguish between an original and a copied recording medium. If the original recording medium is copied but the control point values are recalculated to be appropriate for the copied recording medium it can easily be detected that these recalculated values differ from the expected correct values, thus distinguishing a copied disc from the original disc

This invention relates to a method for generating a key identifying a recording medium, to a record carrier, to a playback device, to an encoder and to a system for copy rights control.

It is desirable to be able to identify a recording medium by means of a key that cannot be replicated using ordinary means in order to be able to properly manage digital rights.

Presently keys are included in the data written on the recording medium. To prevent copying of these keys, errors are introduced to certain sectors of the recording medium. The data can be read using error correction but when the data is written on another recording medium the errors as found on the original recording medium cannot easily be duplicated because of limitations of the recorder used for writing the data on another medium. This method is flawed because recorders capable of writing exact bit patterns are able to duplicated the errors. The copied recording medium includes consequently exact cuplicates of the purposely introduced errors and cannot be distinguished from the original recording medium any more, thus circumventing the digital rights management scheme.

It is an objective of the present invention to prevent the circumvention of the digital right management by providing a method for generating a key that is more difficult to duplicate.

In order to achieve this objective the method for key generation comprises the steps of:
determining a control point in a block of input words where the block of input words can be altered by an alteration.
for each alteration of a group of N possible alterations determining, between a group of code words in a first track and a group of code words in a second track which is adjacent to a third track which is adjacent to the first track, a crosstalk value representing the cross talk affecting the third track corresponding to the alteration.
Selecting an optimum alteration, where the optimum alteration is that alteration from the group of N alterations which has a lowest cross talk value,
Altering the data stream using the optimum alteration.
encoding the altered block of input words into code words using a channel code.

The set of values of control points thus created depends on the predicted increase in noise level in a bit based on the bits in adjacent tracks. Because a slight change in the pitch between tracks on the record carrier will result in a shift of the positions of bits relative to bits in other tracks other crosstalk patterns will result. Because of the changes in crosstalk, the values of the control points are no longer the correct values. If the values are updated in order to arrive at acceptable crosstalk levels when a copy is made, the set of values of the control points changes resulting in a change in the key. It can thus be determined that a record medium has been duplicated.

To increase the difficulty in copying a recording medium the reduction in cross talk, from which the key is derived, can be used to reduce the pitch of the tracks on the original ROM disc obtained from a master to the point where the bit error rate reaches the maximum level acceptable by playback devices.

The record carrier, for instance a ROM disc, remains readable but a copy cannot be written with the same small pitch without the use of expensive mastering equipment because not only during reading but also during writing bits on adjacent tracks are affected by cross talk.

The recordable medium thus will not be able to support the same track pitch but has to use a larger pitch between tracks to produce a reliable recording medium.

This results in a shift of the relative position of bits and consequently in other values of the control points, i.e. another key.

The number of bits per track would have to be kept indentical between the original, for instance a ROM disc with a small track pitch, and the recording medium onto which a copy of the data is to be recorded. This is not easily feaseable.

Since the key cannot be easily duplicated it is a reliable indication whether the recording medium is an original or a copy.

To verify that a recording medium is an original, the key can be retrieved from the recording medium by determining the value of the control points.

Since a copied recording medium made by a bit copy process would have the same values for the control points it is required to verify that the values of the control points are the correct ones corresponding to the alignment of the bits in adjacent tracks. If, because of the copying process, the bit positions on a first track has moved relative to a bit position on a second track the cross talk will differ from the original recording medium and would require at some control points a different control point value in order to achieve the lowest crosstalk possible.

For this purpose for some sections of the recording medium the data is read and the control point values are recalculated. If the recalculated control point values don't match the control point values on the recording medium the recording medium is not an original disc.

During read-out the relative bit positions must be known to be able to recalculate the control point values. This can be achieved by using a multi spot read-out approach.

This ensures that the bit positions relative to each other are known.

Since the third track is only the victim of the cross talk and the control point values are based solely the crosstalk which in turn is only dependent on the content of the first and second track, the multi spot read-out must have at least two spots one covering the first track and one covering the second track. Since the second track is adjacent to the third track which is in turn adjacent to the first track the read-out spots must be two tracks apart instead of the usual one track apart.

Alternatively, if the read-out spots are one track apart, i.e. reading adjacent tracks, the relative bit positions can be determined by first determining the relative bit positions of the third track relative to the first track and subsequently the relative bit positions of the second track relative to the third track, thus creating a relation between the bit positions of the second track and the bit positions of the first track as required for recalculating the control point values.

The playback device can comprise means for verifying the key on the recording medium, or the key can be used for encrypting and decrypting the data stored.

Alternatively the key can be verified remotely by a central verification site over a connection between the playback device and the central verification site. After verification the real encryption key can be provided.

The key is effectively a by-product of the cross talk reduction and thus directly linked to physical properties of the-recording medium.

In order to keep the crosstalk between neighboring tracks on a record carrier at an acceptable level the tracks are positioned relatively far apart. The closer together the higher the crosstalk so the maximum allowable crosstalk defines a minimum distance between the track, the minimum track pitch.

A control point is a point in the data stream where the subsequent part of the data stream can be influenced. By calculating for each of the options at the control point the resulting subsequent part of the data stream and selecting that option at the control point that results in the lowest crosstalk at a given point on the record carrier the cross talk. This lower crosstalk can than be traded in, in the regular fashion, for a reduced track pitch. Thus by applying the cross talk reduction the improvement in crosstalk and resulting improvement in signal to noise ratio allows other parameters affecting the signal to noise ratio to be chosen such that the improved signal to noise ratio is worsened again to the minimum acceptable level. The track pitch can thus be reduced to a pitch that without the cross talk reduction would not be supported by the playback devices.

By limiting N to 2 a single bit or a choice of only 2 options suffices to control the crosstalk. This simplifies the calculations to be performed by the recording device and the playback device. The control point value can have two values which is sufficient when the key comprises many control points.

An embodiment of the method is characterized in that the control point is a bit insertion point. By inserting a bit into the data stream at predefined places in order to allow the playback device to distinguish the inserted bit, the encoding of the subsequent data stream can be influenced. When a bit with a value of ‘0’ is inserted at the bit insertion point a different encoded data stream will result then when a bit with a value of ‘1’ is inserted. After calculating the encoded data stream, the bit corresponding to the calculated data stream which results in the lowest crosstalk value is inserted into the data stream at the bit insertion point and encoded. The calculation can be executed for the subsequent data stream up to the next bit insertion point so that the sections of the data stream between the bit insertion points are each individually optimized for crosstalk.

By using bit insertion it is very easy for the playback device to retrieve the key because the position of the inserted bits representing the key is known.

An embodiment of the method is characterized in that the control point is a code word replacement point

Instead of a bit insertion point a code replacement word can be chosen.

Many codes have code words or sequences of code words that can never occur when encoding data streams. Such a code word can be used to change the crosstalk. A table is created that is known to both the recording device and the playback device. When the recording device encounters a code word from the table it has the option of leaving the code word in the encoded data stream or to replace the code word with the replacement code word according to the table. By choosing the replacement code words from the set of code words that can never occur the playback device is able to distinguish the replacement code word from the other code words in the encoded data stream and replace the replacement code word with the corresponding code word of the table. The choice of replacement code word can be made dependant on the state of the coder, comparable to the method used in EFM-plus encoding and decoding. The method of altering a data stream using replacement code words is disclosed in patent application EP 02076424.7. The recording device chooses whether to replace the code word by the replacement code word depending on the calculated effect on the crosstalk. Because of the NRZI encoder used to encode the encoded data stream into NRZI format suitable for the recording medium the replacement code word can affect the subsequent NRZI encoded data stream by differing in the number of ‘1’ bits by an odd number compared to the code word to be replaced. Changing the number of ‘1’ bits from even to odd or from odd to even means that all subsequently NRZI encoded bits coming out of the NRZI coder will change polarity because a ‘1’ going into the NRZI coder means a change in level at the output of the NRZI coder.

When retrieving the control values for the key the playback device must search for code words that normally do not occur in the channel code, i.e the playback device must look for replacement code words. The position of the replcement code word can be used as part of the key, or the fact whether a replacement code word was found or a code word that could be replaced according to the table was found.

For instance if a replacement code word was found the value of the control point is considered to be ‘1’ while when a code word was found that could be replaced according to the table, but wasn't replaced, the value of the control point is considered to be ‘0’.

Alternatively the replacement code words and code words that could be replaced can form part of the key by themselves, where the key consist of a unique sequence of the code words and replacement code words from the table.

A further embodiment of the method is characterized in that a crosstalk value is determined calculating a running digital sum value of an exclusive NOR operation performed bitwise on the group of code words in the first track and the group of code words in the second track.

When verifying the control point values the cross talk for some sections of the recording medium must be verified to be appropriate for the corresponding section.

The crosstalk between tracks is lowest when the bits in the first track have the opposite polarity of the bits in the second track. Since the perfect situation cannot be obtained because in that case the contents of one track would dictate that the contents of the second track must be the precise inverse of the contents of the first track, the method determines a digital sum value to obtain an indication of the amount of bits located close to each other but on the second track which are of opposite polarity. The exclusive NOR operation determines whether bits on the first track are the opposite polarity of the bits on the second track which are located in corresponding bit positions. In this way a bit wise comparison of a group of bits in the first track to a group of bits in the second track is achieved. If the digital sum is low the polarity of the group of bits in the first track differs substantially from the polarity of the group of bits in the second track, i.e. crosstalk is low. If the digital sum is high the polarity of the group of bits in the first track resembles the polarity of the group of bits in the second track, i.e. crosstalk is high.

A further embodiment of the method is characterized in that the group of code words in the first track is limited to a section of the first track and that the group of code words in the second track is limited to a section of the second track and that the section of the first track is aligned perpendicular to a reading direction of the first track with the section of the second track.

Instead of calculating the digital sum for complete tracks the calculation can also be performed for only a section of tracks that are aligned perpendicular to the reading direction. This requires more control points to be used but this results in improved control over the crosstalk in smaller areas allowing a better optimization. It is of course imperative to have the sections of the tracks involved in the bitwise exclusive NOR operation exactly aligned, i.e. the start of the section on the first track must be aligned with the start of the corresponding section on the second track and the end of the section on the first track must be aligned with the end of the corresponding section on the second track.

The data can be stored in the tracks in several ways without affecting the effectiveness of the invention:

Data represented by pits on an optical recording medium.

Data represented by modulation of the track position on an optical recording medium.

Data represented by magnetic regions on a optical/magnetic or magnetic recoding medium.

Wherever the data is represented by physical differences in the recording medium and the data is read out in a way that bits in close proximity to the bit being read can increase the read or write noise level by crosstalk the invention can be applied.

The invention will now be described based on figures.

In order to distinguish more clearly between the overall encoder and the encoders that are comprised within the overall encoder, the encoders comprised in the overall encoder are called ‘coder’ while the overall encoder is referred to as ‘encoder’.

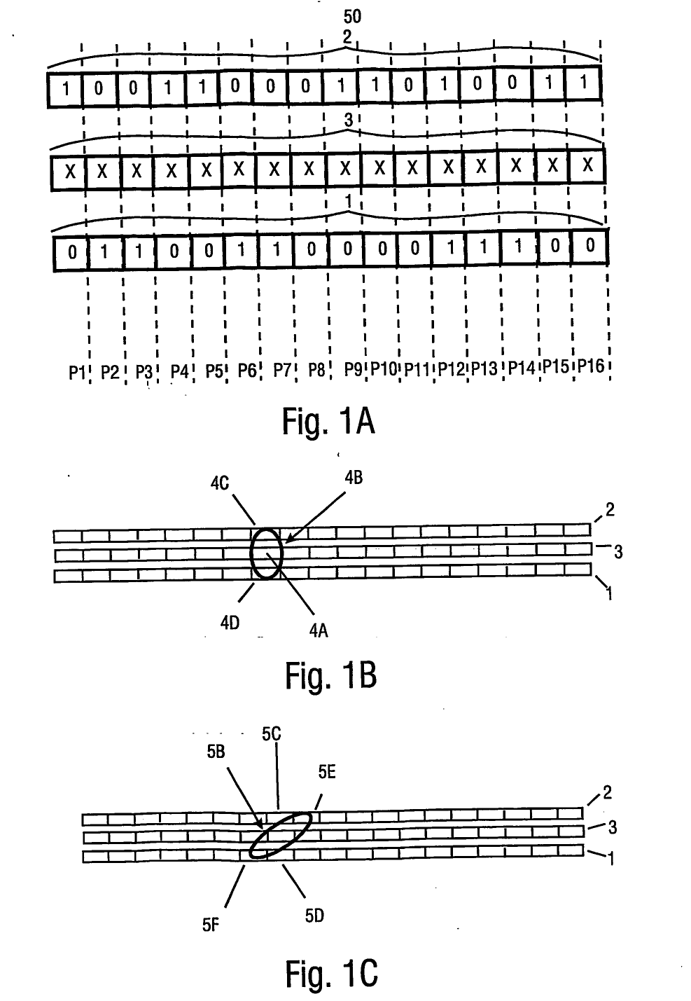

FIG. 1A shows a section of adjacent tracks

FIG. 1B illustrates the concept of crosstalk and corresponding bit positions.

FIG. 1C illustrates the concept of crosstalk and corresponding bit positions in relation to another reading spot shape

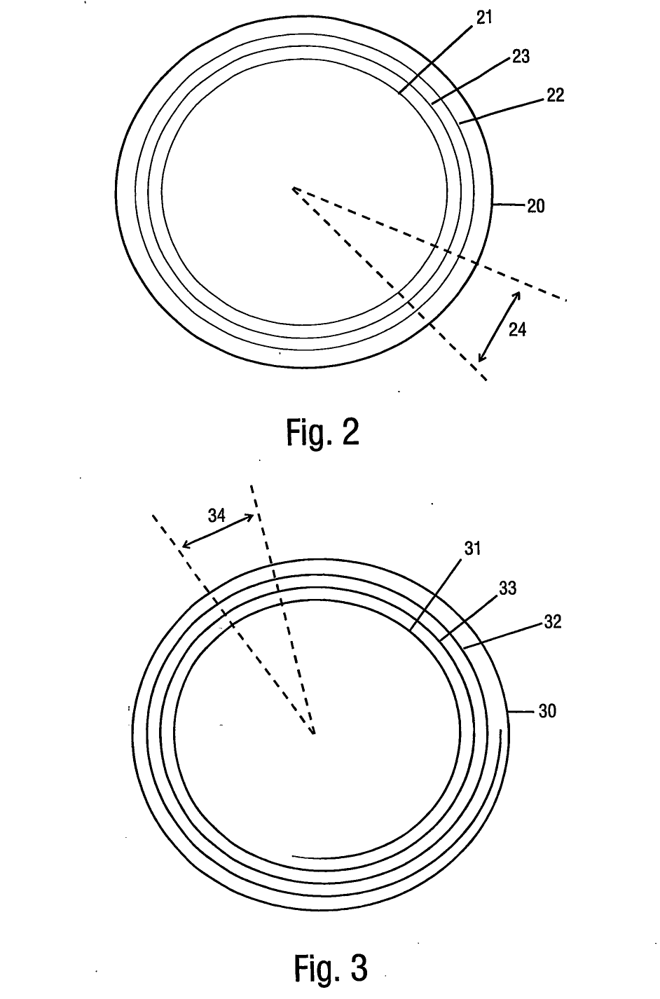

FIG. 2 shows a record carrier in the shape of a disc comprising concentric tracks

FIG. 3 shows a record carrier in the shape of a disc comprising a spiraling track.

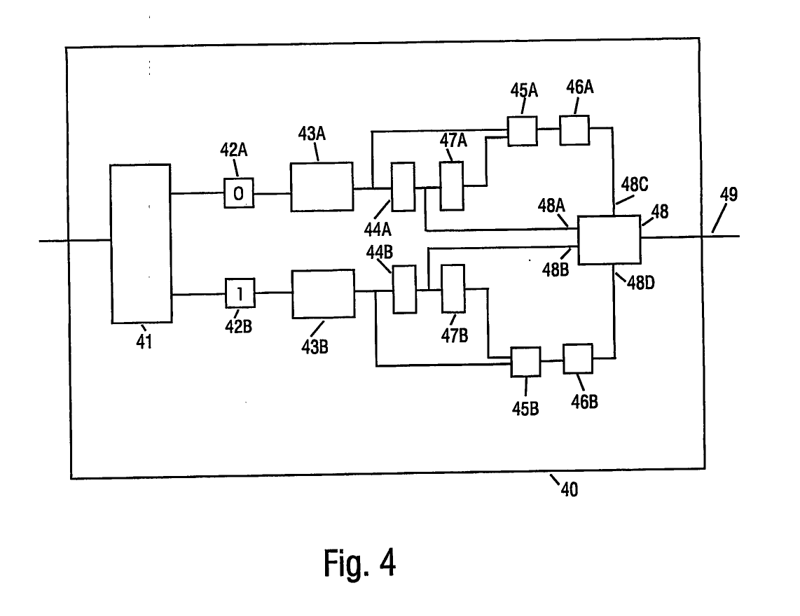

FIG. 4 shows an encoder for encoding the data to be recorded in the tracks

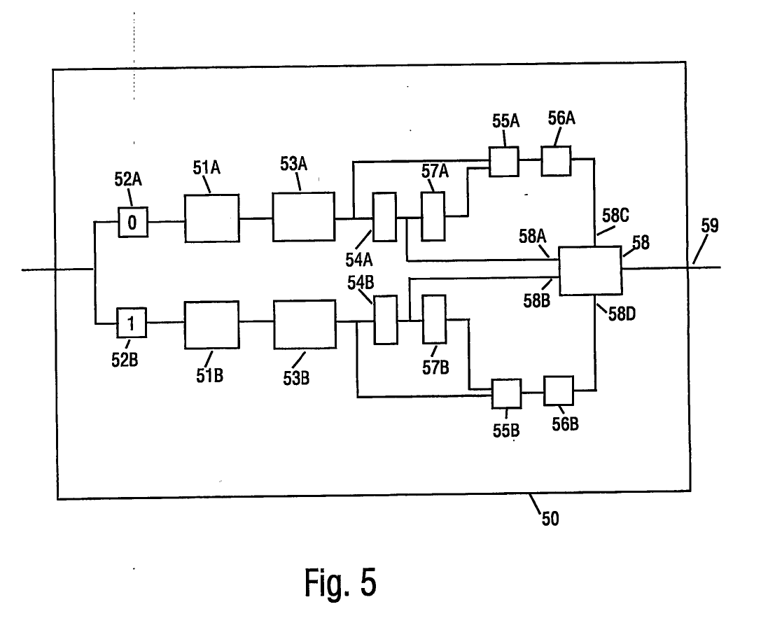

FIG. 5 shows a further encoder for encoding the data to be recorded in the tracks

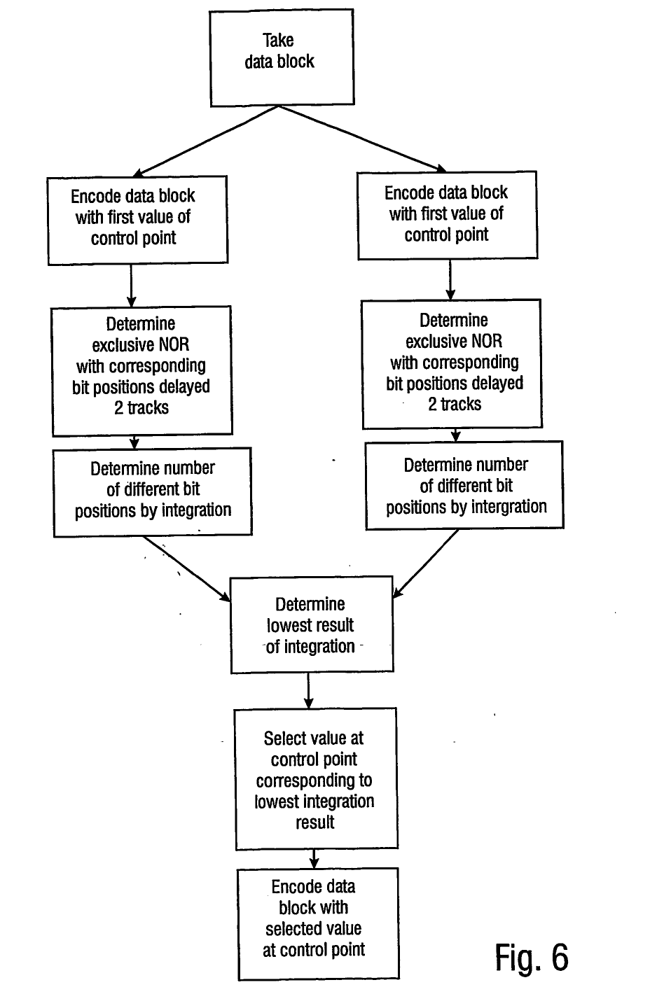

FIG. 6 shows a flow chart of a software implementation of the crosstalk reduction.

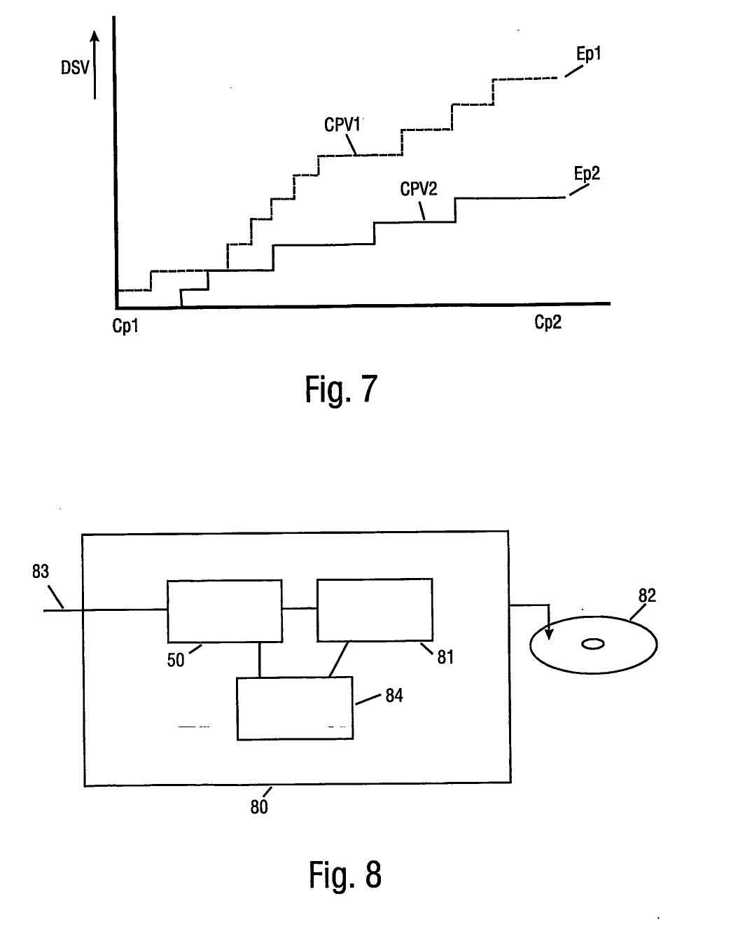

FIG. 7 shows a graph of the digital sum value indicating the level of crosstalk

FIG. 8 shows a recording device comprising the invention

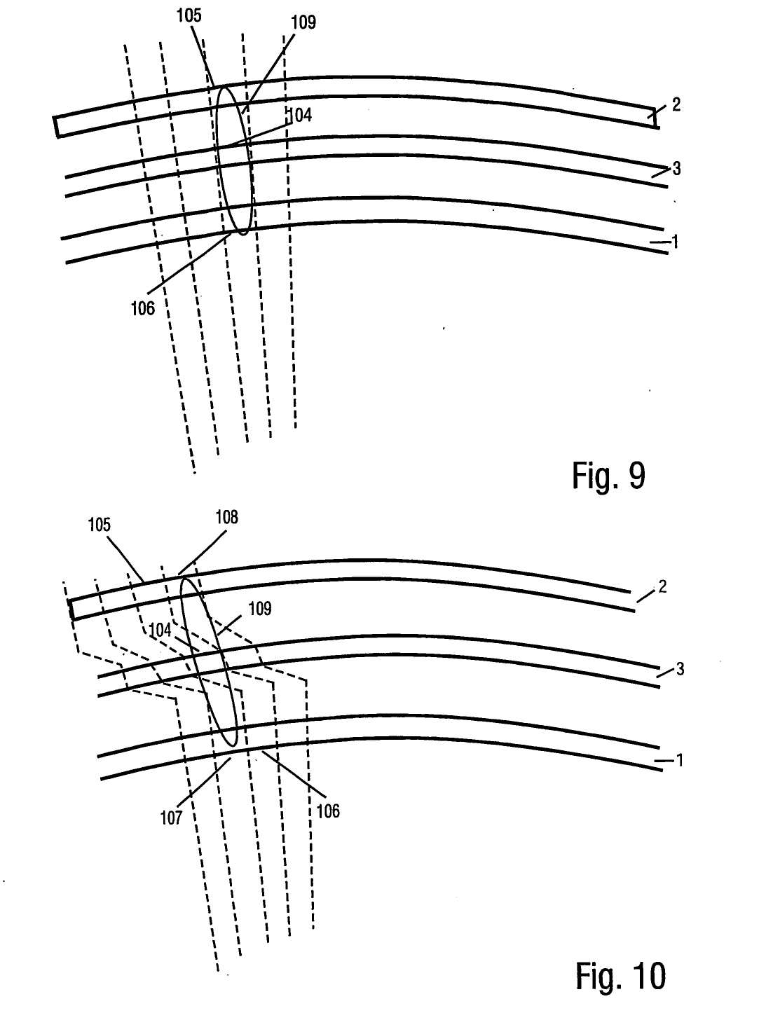

FIG. 9 shows a section of the original recording medium

FIG. 10 shows a the same section when copied to a recording medium with a different track pitch

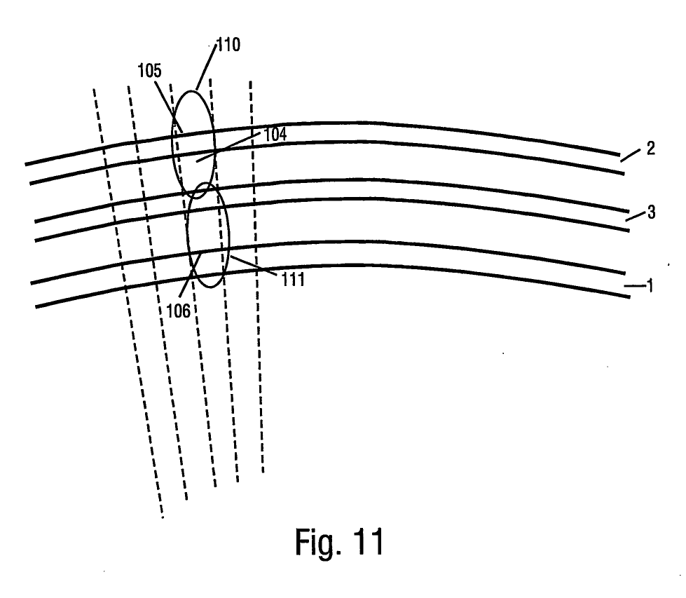

FIG. 11 shows a dual spot read-out.

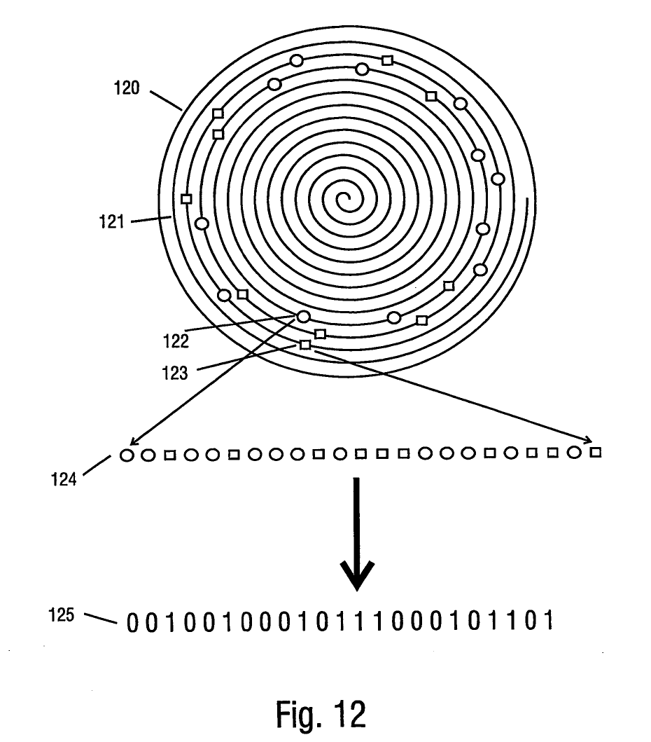

FIG. 12 shows a key identifying the recording medium

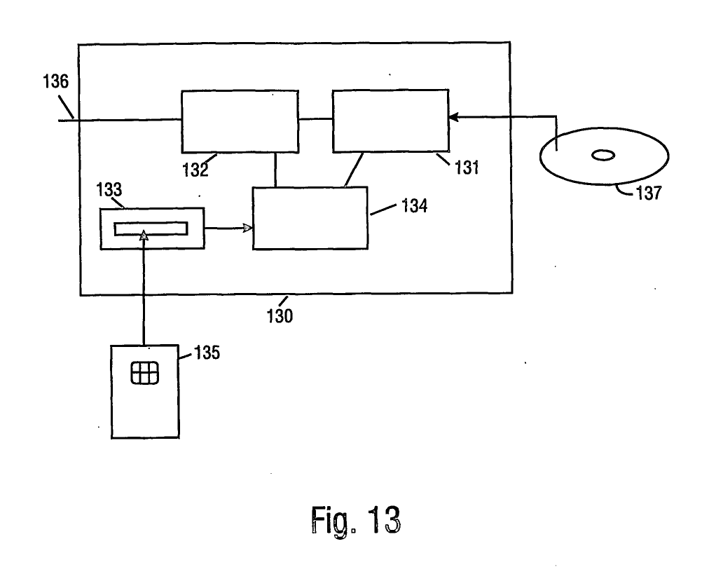

FIG. 13 shows a system for digital right control

FIG. 1A shows a section of adjacent tracks. A first track 1 and a second track 2 are located adjacent to a third track 3.

In order to reduce the crosstalk in the third track 3 the bit values of the bits in the adjacent tracks 1,2 should have the opposite polarities. In the present example the bit values in the second track 2 differ from the bit values in the first track 1 in all positions except the eighth position P8, the eleventh position P11 and the twelfth position P12. It is clear that bits of the second track 2 cannot have the exact opposite bit values of the bit values of the first track 1 because otherwise no information could be recorded in the second track 2. The bit positions of the third track 3 show a bit value of ‘don't care’ because the actual stored value is of no importance to the invention. The measures of the invention are taken in the adjacent tracks 1,2 only. It is the bit values on the adjacent tracks 1, 2 that cause the cross talk. By balancing the crosstalk contribution of a ‘1’ on the first track 1 by a ‘0’ on the corresponding position on the second track 2, and of a ‘0’ on the first track 1 by a ‘1’ on the second track 2 the overall influence of the adjacent tracks 1, 2 on the data stored in the third track 3 is reduced.

Because the bit values of the first track 1 and the second track 2 in position P8 are both ‘0’ the bit values are not opposite and contribute to the cross talk in the same way, thus adding to the crosstalk and increasing the noise level of the data bit in position p8 in the third track 3. The same is true for the twelfth position P12 where the bit value of both the first track 1 and the second track 2 are ‘1’, thus not balancing each other but contributing to the crosstalk in the same way.

The data stored in the second track 2 should be in as many positions as possible the exact opposite of the data stored in the first track 1 in corresponding bit positions.

FIG. 1B illustrates the concept of crosstalk and what corresponding bit positions are.

Shown are three tracks 1, 2, 3 where data is stored. The circle indicates the size of the reading spot 4B. When the track pitch is reduced the data bits 4C, 4D comprised in the third track's 3 neighboring tracks 1,2 are included in the area covered by the reading (or writing) spot 4B and thus contribute to noise level when reading the data bit 4A of the third track. These included data bits 4C, 4D are described in this document as being in corresponding bit positions on the first track 1 and on the second track 2.

The reading direction of each track is in the direction of the elongation of the track.

With the reading spot 4B as shown in figure IB the data bits 4C, 4D that are included in the reading (or writing) spot are aligned perpendicular to the reading direction with the data bit 4A to be read out.

FIG. 1 C illustrates the concept of crosstalk and what corresponding bit positions are in relation to another reading spot shape Shown are three tracks 1, 2, 3 where data is stored. The tilted oval indicates the size of the reading spot 5B. When the track pitch is reduced the data bits 5E, 5F comprised in the third track's 3 neighboring tracks 1,2 are included in the area covered by the reading (or writing) spot 5B and thus contribute to noise level when reading the data bit 5A of the third track. It is clear that depending on the shape of the read-out or write spot the data bits on the neighboring tracks that affect the crosstalk can have different positions relative to the data bit to be read-out or written. Even though the data bits 5E, 5F which contribute to the noise level of the data bit to be read-out are no longer perpendicular aligned with the data bit to be read out the contributing data bits 5E, 5F are still considered to be at corresponding bit positions on the first track 1 and the second track 2. The data bits 5C, SD that would be contributing to the noise level if the read-out spot 5B would be circular are in the case of the elongated oval shape of FIG. 1C no longer contributing to the noise level and are hence no longer considered to be on corresponding bit positions.

FIG. 1C also illustrates that due to the shape of the read-out spot of the write spot multiple bits in the first track 1 and second track 2 can be comprised in the spot and each bit can be comprised in the spot between 0 and 100%. Consequently it is advantageous to apply not only the crosstalk determination to the bits in the first track 1 and the second track 2 that are comprised in the spot to the highest percentage, but also bits directly adjacent to these bits. In order to reflect their lower contribution to the crosstalk a weighing function is applied. The weighing function can reflect the physical distance between the bits causing the crosstalk and the affected bit since crosstalk is a direct function of distance. The weighing can also be based on the physical shape of the read-out spot, the write spot or the shape of the pits.

FIG. 2 shows a record carrier with concentric tracks.

Because of the concentric tracks each track holds a slightly different amount of data compared to the adjacent tracks. This would theoretically pose a problem because the tracks that are supposed to be each other's opposite as much as possible hold different amounts of data. Because there are many tracks and the tracks are located very closely together the difference in the amount of data between a first track 21 and a second track 22 is very small.

When observing the tracks locally, for instance in the pie section 24 indicated, the curvature is very small because of the radius of the track and the size of the pits that the tracks can be considered to be straight and to run parallel for that section of the tracks that is relevant for the crosstalk.

It is furthermore not required to obtain exact opposite polarity of the tracks for all positions since information must be stored which results in differences between the tracks anyway. It is consequently no problem to have different amounts of data in the tracks since it is the overall reduction in crosstalk by striving to opposite polarity for as many bit positions as possible that will contribute to a lower Bit Error Rate in the third track 23.

FIG. 3 shows a record carrier with a track spiraling outward.

When observing the tracks locally, for instance in the pie section 34 indicated, the curvature is very small because of the radius of the track and the close proximity of the tracks compared to the radius of the tracks. The sections of the tracks that are adjacent to each other can be considered to be sections of adjacent concentric tracks as discussed in FIG. 2 instead of sections of a spiraling track. The discussion of FIG. 2 is thus also valid for the case where there is a single spiraling track, spiraling inward or outward.

FIG. 4 shows an encoder 40 comprising an coder 41. The data to be recorded on the record carrier is presented to the input of the coder 41, is encoded by the coder 41 and the encoded data is provided at the output of the coder 41. From the output of the coder 41 the encoded data is passed to the input of the first bit insertion means 42A and to the input of the second bit insertion means 42B. The first bit insertion 42A means inserts a ‘0’ bit at predetermined control points in the encoded data stream. The second bit insertion means 42B inserts a ‘1’ bit at predetermined control points in the encoded data stream. The first bit insertion means 42A provides the encoded data stream comprising ‘0’ bits at the predetermined control points to the first NRZI coder 43A which encodes the data and provides the resulting NRZI encoded data based on the data with the ‘0’ bits at the predetermined control points to the first delay means 44AB and an input of the first exclusive NOR means 45A. The second bit insertion means 42B provides the encoded data stream comprising ‘1’ bits at the predetermined control points to the first NRZI coder 43B which encodes the data and provides the resulting NRZI encoded data based on the data with the ‘1’ bits at the predetermined control points to the second delay means 44B and the input of a second exclusive NOR means 45B. The first delay means 44A delays the data coming from the first NRZI coder 43A for the duration of one track and provides the delayed data to the third delay means 47A and to a first input 48A of the selection means 48. The second delay means 44B delays the data coming from the second NRZI coder 43B for the duration of one track and provides the delayed data to the fourth delay means 47B and to a second input 48B of the selection means 48. The third delay means 47A delays the delayed data coming from the first delay means 44A by the duration of a track and provides the data, which is now delayed by the duration of two tracks compared to the output of the first NRZI coder 43A, to the second input of the first exclusive NOR means 45A.

The fourth delay means 47B delays the delayed data coming from the second delay means 44B by the duration of a track and provides the data, which is now delayed by the duration of two tracks compared to the output of the second NRZI coder 43B, to the second input of the second exclusive NOR means 45A. The output of the first exclusive NOR means 45A is provided to the input of the first integrator means 46A, which integrates the output data provided by first exclusive NOR means and provides the result of this integration to the third input 48C of the selection means 48. The output of the second exclusive NOR means 45B is provided to the input of the second integrator means 46B, which integrates the output data provided by second exclusive NOR means and provides the result of this integration to the fourth input 48D of the selection means 48. The selection means 48 determines whether the content of the first delay means 44A or the content of the second delay means 44B results in a lower crosstalk, and provides the content of that delay means to the output of the selection means 48. The selected content is provided by the output of the selection means to the output 49 of the encoder 40.

The determination is done for a section of data that is present in the first delay means 44A and in the second delay means 44B. Once a selection is made the integrator means 46A, 46B are reset to start the determination for the next section of data again.

The exclusive NOR means determine the differences between the current data and the date that is delayed for the duration of 2 tracks. The current data corresponds with the third track 3 in FIG. 1. The data that is delayed for the duration of two tracks corresponds to the second track in FIG. 1.

The exclusive NOR means 45A, 45B thus determines the differences between the second track 2 and the first track 1 in FIG. 1 for each bit position. The third track 3 in FIG. 1 is ignored for the determinations since it is only the victim of the crosstalk, not a contributor.

The integrators 46A, 46B effectively count the number of bit positions which are equal between the content of the delay means 44A, 44B and the delayed data. A high number coming from the integrator indicates many bit positions with equal bit values. A low number coming form the integrator indicates many bit positions with unequal bit values. Since the determination is performed for both the ‘0’ value and the ‘1’ value of the inserted bit at the predetermined control points the selection means receives two indications, one from the first integrator 46A, indicating the amount of crosstalk in case a ‘0’ is inserted, and one from the second integrator, indicating the amount of crosstalk in case a ‘1’ is inserted. By selecting the data corresponding to the integrator that provides the lowest integrated output value, the lowest crosstalk on the record carrier is achieved.

It is to be noted that although the example uses a parallel determination of the inserted bit at the predetermined control point that yields the lowest cross talk and illustrates this example in hardware, it is equally suitable to implement this principle in a serial fashion, i.e. first determining the crosstalk for an inserted bit value of ‘0’ and then determining the crosstalk for an inserted bit value of ‘1’, then selecting the inserted bit yielding the lowest crosstalk and encoding the data using that inserted bit value for recording on the record carrier. This can of course also be done in software on a processing means instead of in hardware.

It should further be noted that although the invention was illustrated using bit insertion at predetermined control points other methods to affect the way the data is encoded and decoded exist that can just as easily be applied. An example of this is code word replacement where during the encoding some code words, based on a predetermined table, or sequences of code words are replaced by the coder 41 by other code words that can never occur. The code words that can never exist affect the way the data is encoded by the NRZI coders 43A, 43B, for instance by differing an odd number of ‘1’ from the replaced code word, and can thus affect the amount of crosstalk. During decoding the decoder 91, instead of removing inserted bits, replaces the code word that can never exist with the corresponding code word from the predetermined table in order to restore the original data.

FIG. 5 shows a similar encoder 50 as the encoder 40 of FIG. 4 but now modified to guarantee that the resulting code words produced by the encoder 50 comply with the channel constraints. The elements 42A, 42B, 43A, 43B, 44A, 44B, 45A, 45B, 46A, 46B, 47A, 47B, 48A, 48B, and 49 in FIG. 4 correspond respectively to the elements 52A, 52B, 53A, 53B, 54A, 54B, 55A, 55B, 56A, 56B, 57A, 57B, 58A, 58B and 59 in FIG. 5. The coder 41 of FIG. 5 is split into two identical coders 51A, 51B because the two versions of the data stream, one with inserted bits with bit value ‘0’ at the control points and one with the inserted bits with bit value ‘1’ at the control points, have to be encoded to determine which bit value of the inserted bit at the control point yields the lowest crosstalk To guarantee that the resulting code words comply with the channel constraints the bit insertion means 52A, 52B are moved to a position before the first coders 51A, 51B instead of between the first coder 41 and second 43A, 43B coders of FIG. 4. When inserting a bit into the encoded data stream, as shown in FIG. 4 where the bits are inserted after the first coder 41, the channel constraint can be violated. When the bits are inserted at predetermined control points in the data stream before the coders 51A, 51B where the data stream is not yet encoded the inserted bits are included in the encoding. All code words produced by the coders 51A, 51B comply with the channel constraints. The code words of the encoder 50 as shown in FIG. 5 therefore also comply with the channel constraints.

FIG. 6 shows the steps of a software implementation of the invention. A block of data is taken from the input stream. The block of data is located between two control points.

Next, two operations are to be performed, either serially or in parallel.

First a value is chosen for the control point and the data block from that control point until the next control point is encoded. The resulting bits are compared to the bits at corresponding positions in the track before the previous track. This is achieved by performing a bit wise exclusive NOR operation on the encoded bits and bits located in corresponding positions in the track before the previous track, i.e. bits that are delayed by two tracks.

The exclusive NOR operation results in a ‘1’ for each position where the encoded bit and the bit located in the corresponding position in the track before the previous track have the same bit value, i.e. both have the bit value ‘0’ or both have the bit value ‘1’.

An integrator is used to count the number of ‘1’s resulting from the exclusive NOR operation. By counting the number of ‘1’s an indication of the cross talk is obtained. A high number of ‘1’s means that a high level of crosstalk win present.

A low number of ‘1’s means that a low level of crosstalk and consequently low contribution to the noise level of the data located on the track between the two tracks being processed.

Then a second value is chosen for the control point and the data block from the control point until the next control point is again encoded but now with a different control value. The resulting bits are compared to the bits at corresponding positions in the track before the previous track. This is achieved by performing a bit wise exclusive NOR operation on the encoded bits and the corresponding bits located in the track before the previous track, i.e. bits that are delayed by two tracks.

The exclusive NOR operation results in a ‘1’ for each position where the encoded bit and the bit located in the corresponding position in the track before the previous track have the same bit value, i.e. both have the bit value ‘0’ or both have the bit value ‘1’.

An integrator is used to count the number of ‘1’s resulting from the exclusive NOR operation. By counting the number of ‘1’s an indication of the cross talk is obtained. A high number of ‘1’s means that a high level of crosstalk will present.

A low number of ‘1’s means that a low level of crosstalk and consequently low contribution to the noise level of the data located on the track between the two tracks being processed.

The results of the two integrators are compared and the value for the control point resulting in an encoding resulting in the lowest of the two results is then chosen.

The value is assigned to the control point and the encoding is now repeated to yield the final data to be recorded on the record carrier.

It is to be noted that this last encoding step can be avoided by using a buffers in which both versions of the encoded data block are stored and after comparison of the results of the integrators the version of the encoded data block corresponding to the lowest result of the integrator is read from the buffer instead of being recalculated.

FIG. 7 shows the digital sum value as calculated, by integrating the output of the exclusive NOR, for a data block between a first control point CP1 and a second control point CP2. The digital sum value can only increase since it is the integration of the number of corresponding bit positions with equal bit values. Shown are two curves, a first curve corresponding to the data block being encoded with a first control point value CPV1, the second curve corresponding to the same data block being encoded with a second control point value CPV2.

The first end point value EP1 is the final value of the integration at the end of the data block when the first control point value CPV1 is used when encoding. The second end point value EP2 is the final value of the integration at the end of the data block when the second control point value CPV2 is used when encoding.

The lowest of the two end point values EP1, EP2 is chosen to be used at the control point CP1 at the beginning of the data block. This results in the encoded data block causing the lowest crosstalk in the neighboring track as explained above

FIG. 8 shows a recording device comprising the invention.

The recording device 80 comprises an encoder 50, receiving data to be stored on the record carrier from an input 83. The encoder 50 comprises the functionality of the encoder 50 of FIG. 5. The encoded data is then passed on to the bit engine 81 which processes the data and records the data on the record carrier 82 in the regular fashion.

Both the bit engine 81 and the encoder 50 are controlled by the controlling means 84, for instance a microcontroller, again in the regular fashion of a recording device.

The description of the figures above relate to the generation of the recording medium comprising the control points. Now that the control points are present on the recording medium the recording medium is identifiable by it's unique set of control point values in the control points.

The description of the following FIGS. 9 through 13 explains how a recording medium with a unique set of control points can be identified.

FIG. 9 shows a section of the original recording medium The reference numbers for the tracks have been maintained, as anywhere in the figures, exactly as for figure la

When the third track 3 on the original recording medium is being read out the crosstalk has been optimized during the recording of the recording medium as described in FIGS. 1 through 7. The cross talk in the bit position 104 to be read out in the third track 3 originates from the corresponding bit positions 105, 106 on the adjacent tracks 1, 2. Consequently the bit error rate is low enough to reliably read the bit position 104 to be read on the third track 3. The pitch of the tracks 1, 2, 3 has a value which differs from the non-crosstalk reduced recording media

FIG. 10 shows a the same section when copied to a recording medium with a different track pitch.

Because of the different track pitch bit positions of the previously corresponding bit positions 105, 106 have moved relative to the bit position 104 to be read out As indicated by the read-out spot 109 the previously non-corresponding bit positions have become corresponding bit positions 107, 108, from now on referred to as the new corresponding bit positions 107, 108, for the copied recording medium. The bit values of these new corresponding bit positions have no direct relation to the previously corresponding bit positions 105, 106. The value of the control point affecting the crosstalk caused by the new corresponding bit positions would-consequently have to change to accommodate the shift in bit positions.

When a copy is made there are two choices:
The values of all control points are kept identical to the original. Because of the shift of the bit positions resulting from changes in the track pitch several of the values of the control points will no longer be valid. When the copied recording medium is verified it can easily be detected that the values of the control points are incorrect, indicating that the recording medium is not an original but a copy.

The detection is effected by reading data from the recording medium and recalculating what the values of the control points would be if the data were to be recorded on the present recording medium. This recalculation results in part of the values of the recalculated control point differing from the values of the control points on the recording medium.
The values of all control points are recalculated before the copy is recorded. This will automatically result in the values of the control points being different from the original recording medium.

It is thus possible to distinguish between the original recording medium and the copied recording medium. Once it has been determined that a recording medium is an original or a copy, regular copyright control schemes can be applied.

FIG. 11 shows a dual spot read-out.

By using a read-out system with at least two spots multiple tracks can be read at the same time. In this way the relative positions of the bit positions 105,106 read by the spots 110, 111 are defined by the relative positions of the read-out spots 110, 111.

An offset between the two spots does not pose a problem for detecting the correct alignement of the bit positions on the adjacent tracks. One of the possible solutions lies in the fact that on the original recording medium an offset between the two spots will result in a constant offset between all corresponding bit positions on adjacent tracks while after a change in track pitch the offset increases constantly along the tracks. Thus, an increasing non-constant offset indicates that the control points can no longer be valid for the recording medium and that it consequently cannot be an original. When a spiral shaped track is used the increase in offset on a copied recording medium is cumulative, increasing the offset towards the end of the spiral making detection even easier.

Alternatively use can be made of the crosstalk by using a single spot covering both the bit position 104 to be read as the corresponding bit positions 105, 106.

Such a read-out spot could for instance be obtained by enlarging the read-out spot by slightly defocusing of the read-out spot.

Since all three bit positions then contribute to the read-out a multi level read-out signal is obtained. This multi level read-out signal for several consecutive bit positions would allow uniquely relating the bit positions between the tracks covered by the read-out spot When using a single read-out spot it is not possible to tell which track contributes a particular bit value to the multi level read-out signal but because of the known sequence of bit values for each track, with a smaller normally focused read-out spot, the multi level read-out signal can be matched to the data read on the recording medium by simple pattern matching.

FIG. 12 shows a key identifying the recording medium

The recording medium 120 comprises a spiral track 121. The spiral track 120 comprises control points 122, 123. In order to identify the recording medium 120 the values of a set of control points 122, 123 is read from the recording medium 120.

This set can for instance be a number of subsequent control points between a first control point 122 and a further control point 123. The value of a control point is indicated in FIG. 12 as a square or a circle. The sequence of values of control points between the first control point 122 and the further control point 123 is extracted from the recording medium. FIG. 12 shows the sequence 124 of squares and circles. This reflects the fact that not only inserted bits can act as control points but that other methods can be used as well. The sequence of squares and circles can be easily converted into ‘0’s and ‘1’s, i.e. into a simple binary form.

This sequence 125 of ‘0’s and ‘1’s now forms a means to identify the recording medium. Because there can be many control points very large sequences are supported.

The sequence 125 of ‘0’s and ‘1’s can be used solely for identification of the recording medium but also for decrypting the content of the recording medium.

FIG. 13 shows a system for digital right control The recording medium 137 is read by the player 130. For this the player 130 comprises a bit engine 131 which provides the control point values and data required for verification or identification of the recording medium to the processor 134.

The processor 134 verifies whether the values of the set of control points corresponds to information retrieved from a chip card 135 by reading the chip card 135 with a chip card reader 133 that is connected to the processor 134. When the values of the set of control points retrieved from the recording medium 137 matches the information retrieved from the chip card 135 the player verifies that the values of the set of control points are correct for the recording medium by recalculating the control points for the data currently stored on the recording medium 137 and comparing the result to the values of the set of control points retrieved from the recording medium 137.

If the compare results in a close match the recording medium is identified as original and can be played.

The set of control points can be used as a key to enable the decryption of the content of the recording medium. The decryption means 132 receives the decryption key from the processor 134, decrypts the data received from the bit engine 131, and provides the decrypted data to an output 136.

1. Method for generating a key identifying a recording medium comprising code words, the method comprising the steps of
determining a control point in a block of input words where the block of input words can be altered by an alteration.
for each alteration of a group of N possible alterations determining, between a group of code words in a first track and a group of code words in a second track which is adjacent to a third track which is adjacent to the first track, a crosstalk value representing the cross talk affecting the third track corresponding to the alteration.
Selecting an optimum alteration, where the optimum alteration is that alteration from the group of N alterations which has a lowest cross talk value,
Altering the block of input words using the optimum alteration.
encoding the altered block of input words into code words using a channel code
where the alteration is comprised in the key identifying the recording medium

2. Method for generating a key identifying a recording medium comprising code words, the method comprising the steps of
determining a control point in a block of code words where the block of code words can be altered by an alteration.
for each alteration of a group of N possible alterations determining, between a group of code words in a first track and a group of code words in a second track which is adjacent to a third track which is adjacent to the first track, a crosstalk value representing the cross talk affecting the third track corresponding to the alteration.
Selecting an optimum alteration, where the optimum alteration is that alteration from the group of N alterations which has a lowest cross talk value,
Altering the block of code words using the optimum alteration.
where the alteration is comprised in the key identifying the recording medium

3. Method generating a key identifying a record carrier comprising code words as claimed in claim 1 characterized in that the control point is a bit insertion point.

4. Method for generating a key identifying a record carrier comprising code words as claimed in claim 2 characterized in that the control point is a code word replacement point.

5. Method for generating a key identifying a record carrier comprising code words as claimed in claim 1, characterized in that a crosstalk value is determined calculating a digital sum value of an exclusive NOR operation performed bitwise on the group of code words in the first track and the group of code words in the second track.

6. Method generating a key identifying a record carrier comprising code words as claimed in claim 1, characterized in that the group of code words in the first track is limited to a section of the first track and that the group of code words in the second track is limited to a section of the second track and that the section of the first track is aligned perpendicular to a reading direction of the first track with the section of the second track.

7. Method for generating a key identifying a record carrier comprising code words as claimed in claim 5, characterized in that the bitwise exclusive NOR function includes a weighing function reflecting a physical distance.

8. Encoder for generating a key identifying a record carrier comprising code words while encoding a block of input words into a block of code words using a channel code for a recording medium comprising tracks for storage of the block of code words comprising coding means for encoding the block of input words into a block of code words characterized in that the encoder further comprises
Control point alteration means with an input for receiving a data block and an output connected to the encoding means where the control point alteration means is operative to determine a control point in the data block at the input where the data block can be altered and to alter the control point based on an alteration instruction received on a alteration instruction input.
crosstalk determination means with an input connected to the output of the encoding means and an output, operative to determine a first crosstalk value for a first control point alteration and a second crosstalk value for a second control point alteration,
Selection means with an input connected to the output of the crosstalk determination means and an output connected to the alteration instruction input operative to select a control point alteration corresponding to the lowest crosstalk value of the first crosstalk value and the second crosstalk value

9. Encoder according to claim 8, characterized in that the crosstalk determination means is operative to process a group of code words in a first track of the recording medium and a group of code words in a second track of the recording medium which is adjacent to a third track of the recording medium which is adjacent to the first track of the recording medium when determining a crosstalk value representing the cross talk affecting the third track.

10. Recording device comprising the encoder as claimed in claim 8.

11. Recording medium comprising tracks comprising a block of code words, characterized in that the block of code words comprises a first block in a first track and a control point corresponding to the first block, the control point having a value, where the value is based on a cross talk between the first data block in a first track and a second data block in a second track, where the second track is adjacent to a third track which is adjacent to the first track and where a set of control points form a key identifying the recording medium.

12. Recording medium as claimed in claim 11, characterized in that the recording medium has a track pitch between the tracks and that the track pitch varies locally on the recording medium

13. Recording medium as claimed in claim 11, characterized in that the recording medium has a track pitch between the tracks and that the track pitch is smaller than a minimum track pitch accepted by a playback device when no control points are comprised by the recording medium.

14. Playback device for playing back a recording medium as claimed in claim 11, characterized in that the playback device comprises verification means for verifying the key identifying the recording medium

15. Playback device as claimd in claim 14 characterized in that the verification means comprises key retrieval means for retrieving a key from the recording medium data retrieval means for retrieving data from the recording medium and recalculation means for recalculating control points based on a cross talk between a first block of data retrieved from a first track and a second block of data retrieved from a second track, where the second track is adjacent to a third track which is adjacent to the first track and comparison means for comparing the recalculated control points and the key retrieved by the key retrieval means.

16. Playback device as claimed in claim 15, characterized in that the playback device comprises an optical pick-up comprising at least two read-out spots for simultaneously reading a first track and a second track which is adjacent to a third track which is adjacent to the first track.

17. Playback device as claimed in claim 15, characterized in that the playback device comprises an optical pick-up comprising a single read-out spot for simultaneuously reading at least two adjacent tracks

18. Playback device as claimed in claim 17, characterized in that the single read-out spot is a normal read-out spot enlarged by defocussing the normal read-out spot

19. System for copy rights control comprising a recording medium, a server for providing identification information, a play back device comprising verification means for identifying a recording medium based on identification information provided by the server and a key on the recording medium, characterized in that the verification means comprises key retrieval means for retrieving a key from the recording medium, data retrieval means for retrieving data from the recording medium and recalculation means for recalculating control points based on a cross talk between a first block of data retrieved from a first track and a second block of data retrieved from a second track, where the second track is adjacent to a third track which is adjacent to the first track and comparison means for comparing the recalculated control points and the key retrieved by the key retrieval means.

20. System for copy right control as claimed in claim 19 characterized in that the recording medium has a track pitch between the tracks and that the track pitch varies locally on the recording medium in a way unique to a production batch of recording media.
